(19) United States
(12) Patent Application Publication
(10) Pub. No.: US 2006/0242571 A1
(43) Pub. Date: Oct. 26, 2006

(54) Systems and methods for processing derivative featurees in input files

(76) Inventor: Xiaofan Lin, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/111,368

(22) Filed: Apr. 21, 2005

(51) Int. Cl. G06F 17/00

(52) U.S. Cl. 715/523

(57) ABSTRACT

Methods and systems for processing derivative features in input files are described. An input file, e.g., an XML file, may contain elements which are supported by an existing format (e.g., XSL-FO) as well as elements which are not supported by the existing format. Those which are not supported by the existing format are replaced by elements which are supported to implement the derivative feature.

### BACKGROUND

The present invention relates generally to imaging devices and, more particularly, to software files associated with the printing of objects.

Imaging devices play many roles in today's technology society. Local printers, for example, are coupled directly to (or via a network of some type) most personal computers to provide hard copy output capabilities. Larger scale printers, e.g., digital printing presses, are used commercially to print everything from brochures, mass mailings to newspapers, etc. Digital publishing software has been created to enable users to manipulate, and print, different types of objects and layouts of objects to generate sophisticated products.

Digital printing systems, including digital publishing systems and the like, operate on sets of objects to be printed that are read from files, which files can be processed by application software and stored on computer-readable media. Various file formats exist for such files. One exemplary file format is known as XSL-FO, which acronym refers to the Extensible Stylesheet Language Formatting Objects. XSL-FO is a widely used format for data files in the digital publishing field due to, for example, its openness as an XML-based W3C standard and feature set which is suitable for variable data printing (VDP). Various tools exist to parse and render files in XSL-FO format, e.g., the Apache Formatting Object Processor (FOP), which operate to translate the XSL-FO formatted files into printer-ready formats, such as Portable Document Format (PDF).

Although formats such as XSL-FO and tools such as FOP provide open and convenient techniques for creating and managing files usable in digital publishing applications, some features which are popular in publications are not supported by these formats and tools. One such feature is text wrapping, an example of which is shown in FIG. 1(a). Therein, note that the text (represented by horizontal lines) is wrapped around the semi-circular graphic by providing a variable left margin of the text relative to the left edge of the rectangular container 12. The left text margin varies to maintain a certain gap between the edge of the semi-circular graphic and the beginning of the text to provide a pleasing visual aesthetic for the view of the printed document. XSL-FO and FOP do not support text wrapping (the provision of text in a non-rectangular container around the boundary of an object) but instead only support the provision of text in a rectangular container as shown, for example, in FIG. 1(b). Note that a lack of support for text wrapping is simply one example of the limitations of existing file formats and tools associated with digital printing and that other such limitations exist.

The limitations associated with popular file formats and tools can be addressed in a number of ways. One way is for developers of digital publishing applications and systems to wait for a future version of the file format and/or tools to be released which will potentially include the desired feature and feature support. However, this option involves reliance and uncertainty which may negatively impact product development. Another possibility is to try to find a different file format and tools which support the features which are lacking. However, this necessitates system redesign and associated costs each time a new file format and tools are adopted.

Accordingly, it would be desirable to provide methods and systems which enable the addition of features and feature support to existing file formats used in digital publishing systems without waiting for new releases.

### SUMMARY

According to one exemplary embodiment of the present invention, a method for processing an input file to process at least one derivative feature includes the steps of parsing the input file into a plurality of elements, identifying at least one of the plurality of elements that is unsupported by a format associated with the input file and replacing the at least one of the plurality of elements which is not supported by the format with at least two other elements supported by the format, which at least two elements together represent the at least one derivative feature.

### BRIEF DESCRIPTION OF THE DRAWINGS

The accompanying drawings, which are incorporated in and constitute a part of the specification, illustrate an embodiment of the invention and, together with the description, explain the invention. In the drawings:

FIG. 1(a) shows the insertion of text into a non-rectangular container to provide text wrapping around a graphic on a page;

FIG. 1(b) shows the insertion of text into a rectangular container;

FIG. 2 is a system in which the present invention can be implemented;

FIG. 3 is a flow chart depicting a method for processing an input file to support at least one derivative feature according to an exemplary embodiment of the present invention;

FIG. 4(a) is an example of an XML file to be processed according to an exemplary embodiment of the present invention;

FIG. 4(b) is a portion of a document tree generated using the input file of FIG. 4(a);

FIG. 5 is a flowchart depicting a method for handling a derivative feature in an input file according to an exemplary embodiment of the present invention;

FIG. 6(a)-(c) show examples of files pointed to by a derivative feature in the input file of FIG. 4(a);

FIG. 7 illustrates an example of segmenting a polygon container into a plurality of text lines according to an exemplary embodiment of the present invention;

FIG. 8 shows an example of elements in an existing format which are used to replace a derivative feature according to an exemplary embodiment of the present invention; and

FIG. 9 is a portion of a document tree generated after the derivative feature is replaced with elements in the existing format according to an exemplary embodiment of the present invention.

### DETAILED DESCRIPTION

The following description of the exemplary embodiments of the present invention refers to the accompanying drawings. The same reference numbers in different drawings identify the same or similar elements. The following detailed description does not limit the invention. Instead, the scope of the invention is defined by the appended claims.

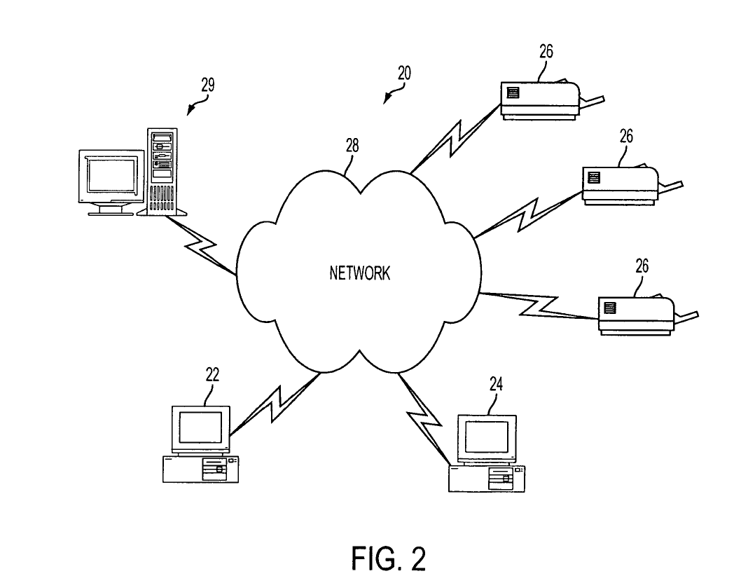

According to exemplary embodiments of the present invention, derivative features can be added to existing digital file formats and systems in a manner which is non-intrusive and which requires minimal development effort and disturbance to existing systems. To provide some context for these exemplary embodiments of the present invention, an exemplary print processing system will first be described with respect to FIG. 2. Generally, the network system 20 of FIG. 2 includes multiple computers 22 and 24 and one or more networked devices illustrated as printers 26. The computers 22 and 24 communicate with the output devices 26 over a data communications network 28. As presented herein, computers 22 and 24 are each intended to represent any of a broad category of computing devices including, but not limited to, a business or personal computer, a server, a network device, a set-top box, a communication device, and the like. It should be appreciated that computers 22 and 24 require no special features or attributes to take advantage of the innovative features of printing systems and techniques according to the present invention. In most implementations, computers 22 and 24 include a display device and an input device, such as a keyboard and/or mouse, for example, wherein the central print system may provide a visual user interface, such as a pull-down menu, for example, when invoked by an end user for the purpose of specifying print job processing attributes. In the illustrated example, the data communications network 28 can include one or more of: the Internet, PSTN networks, local area networks (LANs), and private wide area networks (WANs). Communication between computers 22, 24 and output devices 26 can be via any of a variety of conventional communication protocols. Client computers 22, 24 transfer data or jobs to output devices 26 via network 28. One or more servers 29 may also be coupled to communications network 28. The output devices 26 of FIG. 2 can, for example, be any of a wide variety of conventional printing or other output devices. Such output devices can be physical devices, such as laser printers, inkjet printers, dot matrix printers, facsimile machines or plotters, for example. A printer server 29 can be used to support communications and print job processing between client computers 22, 24 and output devices 26.

According to one exemplary embodiment of the present invention, the print server 29 may receive documents or print jobs in Extensible Markup Language (XML) and transform them using an XSL transformation tool such as Java API for XML Processing (JAXP, see http://java.sun.com/xml/jaxp/indexjsp) to XSL-FO. XSL-FO can then be rendered by FOP into a file format which is adapted for printing, such as Portable Document Format (PDF). As will be appreciated by those skilled in the art, XML files do not include formatting data or any other information indicating how the material stored therein is to be presented. The XSL transformation adds the formatting information to the XML data to generate an XSL-FO file. Exemplary embodiments of the present invention introduce a preprocessing function to the XSL-FO files to expand the types of formatting and other functions which are currently available.

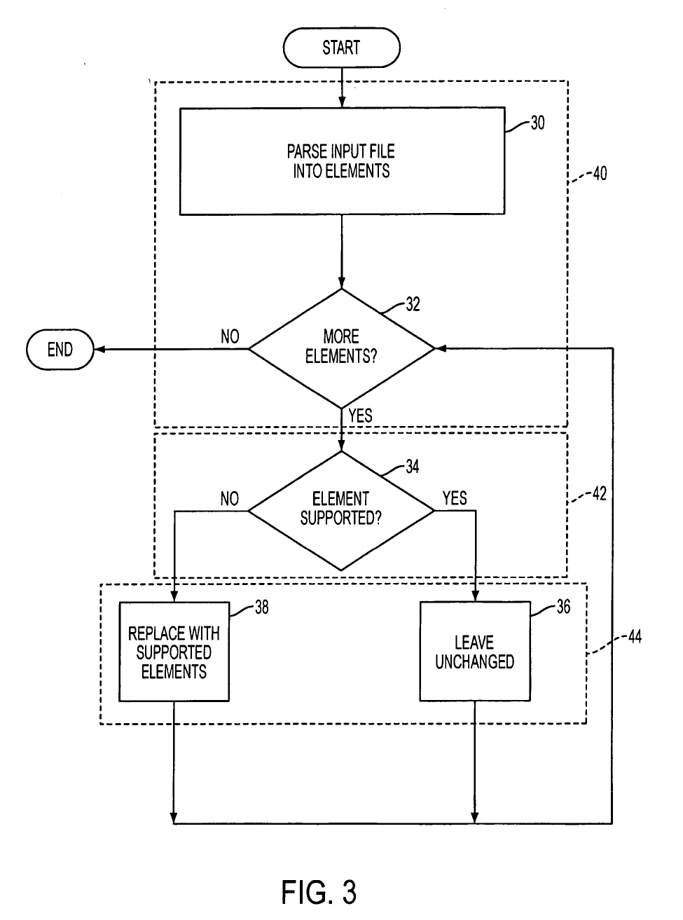

FIG. 3 is a flowchart illustrating an overall method of processing an input file (in this example an XSL-FO file) according to an exemplary embodiment of the present invention to enable implementation of a derivative feature (in this example text wrapping). A derivative feature is a feature which is not currently defined by an existing format (in this example XSL-FO), but which can be implemented using some combination of existing format elements and/or attributes. Elements typically refer to objects to be rendered, e.g., a block of text is an object, whereas attributes typically refer to specific characteristics of the element, e.g., a specified indent for the block of text and a specified font size/type for the block of text. Those skilled in the art will appreciate that an existing format may refer to its elements and/or attributes using other terminology. Moreover to simplify the discussion herein, the term “element” may refer to any one of an element, an attribute, a combination of an element and an attribute, other defined units of an existing format or a derivative feature. Likewise, the term “elements” may refer to any one of multiple elements, multiple attributes, a combination of one or more elements and one or more attributes, other defined units of an existing format or derivative features.

Therein, at step 30, an input file is parsed into its component elements. The output of the parsing step 30 can, for example, be a document tree (e.g., XML-DOM). Each element is then individually processed at steps 30 and 32 to determine if the element is supported by the existing format and tool (e.g., XSL-FO and FOP). If so, then that element is left unchanged at steps 34 and 36.

If, however, the element represents a derivative feature that is not explicitly supported by the existing format and tool, then the process moves to step 38. Therein, the derivative feature is replaced with one or more elements which are part of the existing format and which can be used to perform the function intended by the derivative feature that was originally written to the input file. This process continues until all of the elements in the input file have been preprocessed at which time the flow moves along the “NO” path from decision step 32 to the end of the preprocessing flow. Thereafter the processed elements can be serialized into an output XSL-FO file prior to being used by a downstream processing function.

A more general way to consider the method of FIG. 3 is provided by the dotted lines associated with various method steps. Therein, block 40 refers to a step of parsing the input file into a plurality of elements, block 42 refers to a step of identifying at least one of the plurality of elements that is unsupported by a format associated with the input file and block 44 refers to a step of replacing the at least one of the plurality of elements which is not supported by the format with at least two other elements supported by the format, which at least two elements together represent the at least one derivative feature.

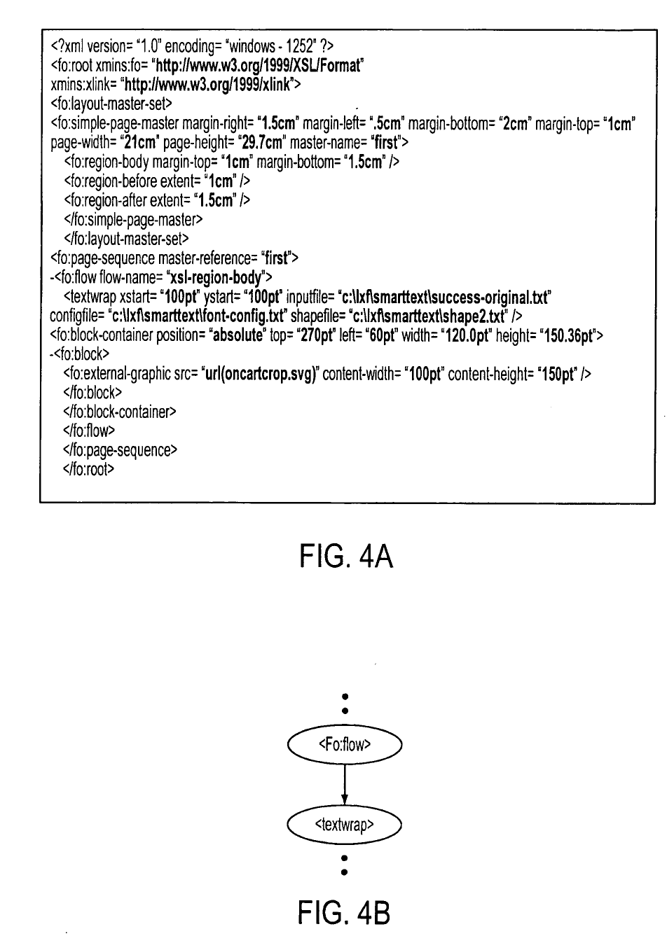

To better understand the manner in which exemplary embodiments of the present invention perform input file processing as described above, a more detailed example of the various steps outlined above with respect to FIG. 3 will now be provided with respect to FIGS. 4-8. FIG. 4(a) illustrates an exemplary XSL-FO input file to be processed in accordance with this exemplary embodiment of the present invention. Therein, a number of different elements are shown which together describe a document to be rendered. In the exemplary input file of FIG. 4(a), one of the lines which reads “<textwrap . . . ” is a derivative feature that is not supported by the existing XSL-FO format, while the remaining elements are supported by this format. The textwrap feature in FIG. 4(a) describes how the text in the text file “success-original.txt” should be displayed in a non-rectangular container in the document to be rendered using the input file of FIG. 4(a).

The input file of FIG. 4(a) is first parsed into its individual elements using a generic XML parsing program. One example of such a program is the Apache Xerces Java XML parser, which is described at www.xml.apache.org. The output of parsing step 30 on the input file of FIG. 4(a) is a document tree with the elements being placed at various levels of the tree. The document tree, e.g., an XML DOM (Document Object Model), provides a hierarchical listing of the elements which allows the elements and derivative features to be accessed for subsequent processing. A graphical representation of a portion of a document tree for the input file of FIG. 4(a) is illustrated as FIG. 4(b) for the elements “<fo:flow>” and “<textwrap>”.

The document tree is traversed at steps 32 and 34 to classify each element as either supported by the existing format or unsupported by the existing format. In this example, the classification can be performed by evaluating the element names, e.g., elements having names beginning with “fo:” are supported by the existing XSL-FO format and will therefore remain unchanged in step 36. By way of contrast, the element “<textwrap . . . ” does not have a “fo:” preamble and, therefore, is classified as being unsupported by the existing format such that it is processed in step 38 to replace the derivative feature with supported elements.

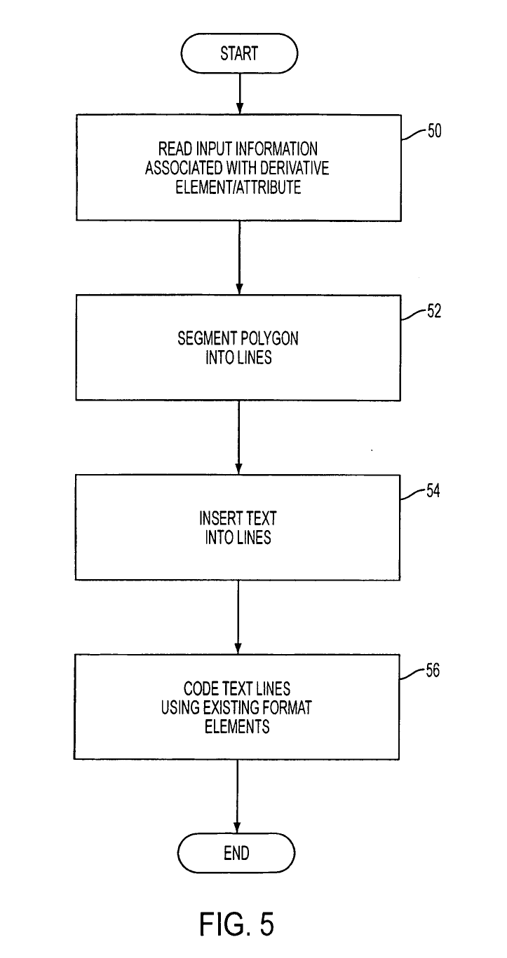

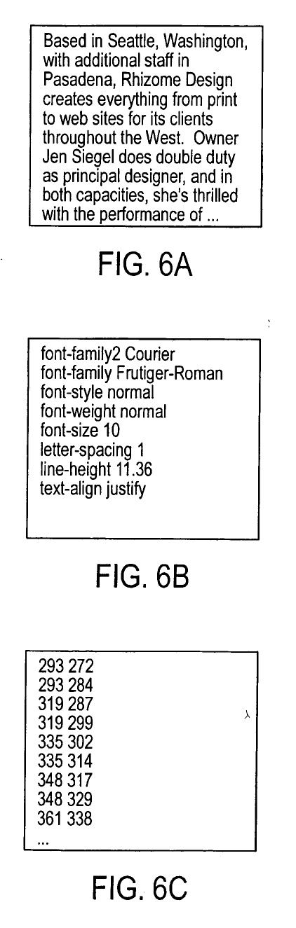

In this exemplary embodiment, the derivative feature is non-rectangular text wrapping. An exemplary process for replacing the text wrapping element with supported elements from the existing format is illustrated in the flow chart of FIG. 5. First, input information associated with the text wrapping element are read into memory at step 50. In the example of FIG. 4(a), this input information includes the xstart and ystart parameters, which together specify the position of the text block to be wrapped on the page, inputfile which points to the text file to be text wrapped, configfile which refers to the formatting configuration, e.g., font family, font style, font size, line height, etc., and shapefile which points to a file that contains the shape description of the polygon into which the text is to be inserted, e.g., by specifying coordinates of all the vertices of the polygon. Examples of the inputfile, configfile, and shapefile are provided as FIGS. 6(a)-6(c), respectively.

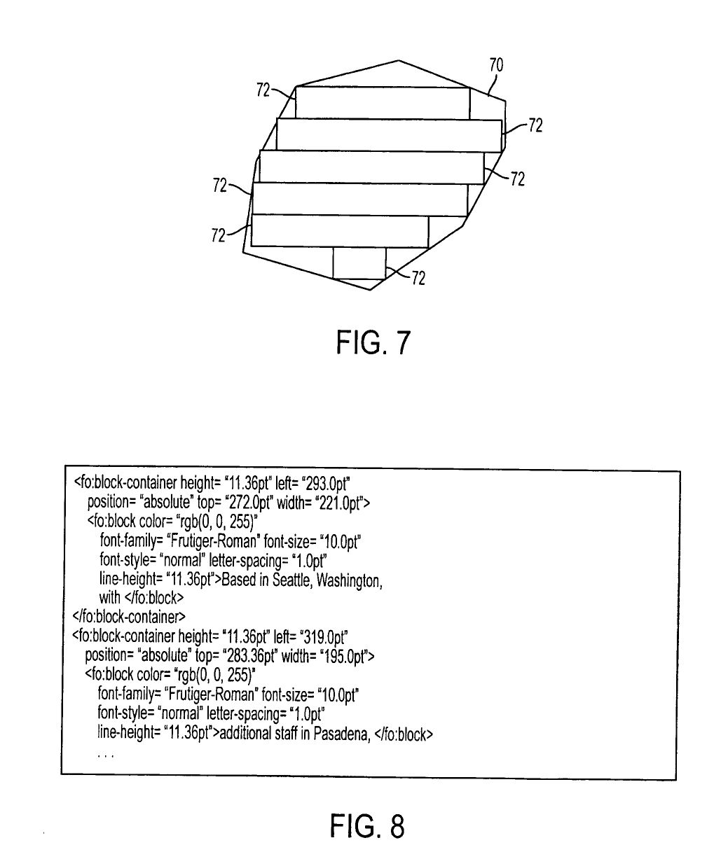

Returning to FIG. 5, after the information associated with the derivative feature is input at step 50, the polygon into which the text is to be inserted is segmented into text lines at step 52. FIG. 7 shows a graphical example wherein a polygon 70 is segmented into a plurality of text lines 72, each having the height specified in the configfile and a width which can be determined based on the boundaries of the polygon 70. Next, at step 54, the text in the inputfile is spread into the lines 72 generated in step 52. This can be accomplished using, for example, a line break algorithm such as that described in the article “Breaking Paragraphs into Lines”, by Donald E. Knuth, Software Practice and Experience, Vol. 11, pp. 1119-1184, 1981, the disclosure of which is incorporated here by reference. Other line breaking algorithms can be used, for example those which may be available in the software tools for parsing and editing files in the existing format. For example, the FOP tool has its own line breaking algorithm which can be employed by exemplary embodiments of the present invention to place words from the inputfile into each line 72 sequentially such that a maximal number of words is placed on each line.

Returning again to FIG. 5, after the text is inserted into lines 72 within polygon 70, the resulting text wrapping configuration is coded using elements which are supported by the existing format, in this example XSL-FO, at step 56. FIG. 8 depicts an example of the output of this step wherein each line 72 is placed in a <fo:block> within a <fo:block-container> using XSL-FO notation. Therein, the width of the <fo:block-container> is equal to the line width previously calculated during the segmentation step 52.

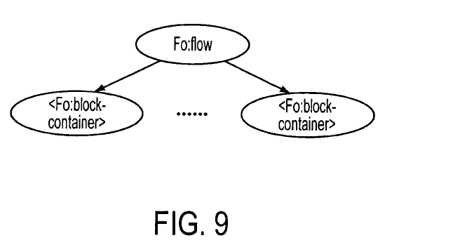

The foregoing example illustrates how a derivative feature can be transformed into its component elements which are available in an existing format, e.g., XSL-FO. This process can be repeated for each derivative feature which is identified in an input file to be preprocessed in accordance with the present invention. Then, the resulting document tree can be saved into a file using only elements which are supported by the existing format for subsequent processing, e.g., rendering by an associated tool such as FOP. FIG. 9 illustrates a portion of a resulting document tree corresponding to that of FIG. 4(b), wherein the textwrapping derivative feature has been replaced with a plurality of <fo:block-container elements> in the document tree.

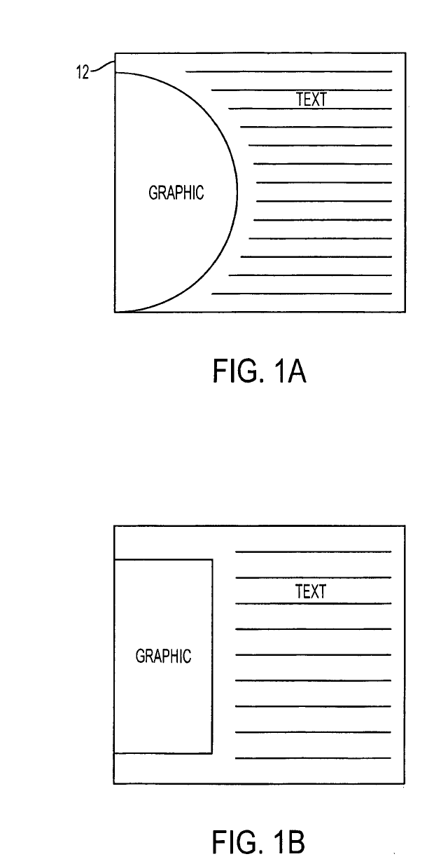

Although the foregoing examples illustrate one specific type of derivative feature (text wrapping), those skilled in the art will appreciate that other derivative features can be implemented using similar techniques. For example, XSL-FO also does not directly support formatting of non-rectangular image objects, e.g., the graphic next to the text in FIG. 1(a), and drop capital objects, e.g., wherein the first letter of a paragraph is printed in a large font and the remaining text (in smaller font) wraps around the first letter. These derivative features can also be implemented using the present invention by converting those derivative features into standard XSL-FO elements using the preprocessing techniques described above.

Referring again to the exemplary system of FIG. 2, the preprocessing functions described herein can be performed by any of the network elements having processing capabilities. For example, preprocessing in accordance with the present invention can be performed by applications running on computers 22 and 24 so that the print job sent to output devices 26 or output device server 29 is already in a standard format. This allows the system to handle the derivative features without changing printer drivers. Alternatively, the preprocessing could be performed in the output devices 26 or output device server 29.

Systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

The foregoing description of exemplary embodiments of the present invention provides illustration and description, but it is not intended to be exhaustive or to limit the invention to the precise form disclosed. Modifications and variations are possible in light of the above teachings or may be acquired from practice of the invention. The following claims and their equivalents define the scope of the invention.

1. A method for processing an input file to process at least one derivative feature comprising the steps of:
parsing the input file into a plurality of elements;
identifying at least one of said plurality of elements that is unsupported by a format associated with said input file; and
replacing said at least one of said plurality of elements which is not supported by said format with at least two other elements supported by said format, which at least two elements together represent said at least one derivative feature.

2. The method of claim 1, further comprising the steps of:
processing each element to determine whether it is supported by said format associated with said input file; and
leaving unchanged each element which is supported by said format.

3. The method of claim 1, wherein said input file contains XML instructions and said format is XSL-FO.

4. The method of claim 1, wherein said at least one element is a text wrapping element.

5. The method of claim 4, wherein said text wrapping element provides formatting information for inserting text into a non-rectangular container.

6. The method of claim 4, wherein said step of replacing further comprises the steps of:
identifying text, and a polygon container into which said text is to be inserted, associated with the text wrapping element;
segmenting said polygon container into a plurality of text lines;
associating each word in said text with one of said plurality of text lines; and
generating, as said at least two other elements, line elements in said format for each of said plurality of text lines.

7. A computer-readable medium containing program instructions which, when executed, perform the steps of:
parsing an input file into a plurality of elements;
identifying at least one of said plurality of elements that is unsupported by a format associated with said input file; and
replacing said at least one of said plurality of elements which is not supported by said format with at least two other elements supported by said format.

8. The computer-readable medium of claim 7 wherein said program instructions further perform the steps of:
processing each element to determine whether it is supported by said format associated with said input file; and
leaving unchanged each element which is supported by said format.

9. The computer-readable medium of claim 7, wherein said input file contains XML instructions and said format is XSL-FO.

10. The computer-readable medium of claim 6, wherein said at least one of said plurality of elements is a text wrapping element.

11. The computer-readable medium of claim 10, wherein said text wrapping element provides formatting information for inserting text into a non-rectangular container.

12. The computer-readable medium of claim 10, wherein said step of replacing further comprises the steps of:
identifying text, and a polygon container into which said text is to be inserted, associated with the text wrapping element;
segmenting said polygon container into a plurality of text lines;
associating each word in said text with one of said plurality of text lines; and
generating, as said at least two other elements, line elements in said format for each of said plurality of text lines.

13. A system for processing an input file to process at least one derivative feature comprising:
means for parsing the input file into a plurality of elements;
means for identifying at least one of said plurality of elements that is unsupported by a format associated with said input file; and
means for replacing said at least one of said plurality of elements which is not supported by said format with at least two other elements supported by said format, which at least two elements together represent said at least one derivative feature.

14. The system of claim 13, wherein said means for identifying further comprises:
means for processing each element to determine whether it is supported by a format associated with said input file; and
means for leaving unchanged each element which is supported by said format.

15. The system of claim 13, wherein said input file contains XML instructions and said format is XSL-FO.

16. The system of claim 13, wherein said at least one element is a text wrapping element.

17. The system of claim 16, wherein said text wrapping element provides formatting information for inserting text into a non-rectangular container.

18. The system of claim 17, wherein said means for replacing further comprises:
means for identifying text, and a polygon container into which said text is to be inserted, associated with the text wrapping element;
means for segmenting said polygon container into a plurality of text lines;
means for associating each word in said text with one of said plurality of text lines; and
means for generating, as said at least two other elements, line elements in said format for each of said plurality of text lines.

19. The method of claim 1, wherein said at least one derivative feature is one of a non-rectangular image and a drop capital letter.

20. The computer-readable medium of claim 7, wherein said at least one derivative feature is one of a non-rectangular image and a drop capital letter.

21. The system of claim 13, wherein said at least one derivative features is one of a non-rectangular image and a drop capital letter.
